(19) United States
(12) Patent Application Publication
(10) Pub. No.: US 2002/0146052 A1
(43) Pub. Date: Oct. 10, 2002

(54) Room-temperature source of single photons based on a single molecule

(76) Inventors: William E. Moerner, Los Altos, CA (US); Brahim Lounis, Bordeaux (FR)

Correspondence Address: LUMEN INTELLECTUAL PROPERTY SERVICES, 45 CABOT AVENUE, SUITE 110, SANTA CLARA, CA, 95051, US

(21) Appl. No.: 10/071,889

(22) Filed: Feb. 7, 2002

Related U.S. Application Data
(60) Provisional application No. 60/266,955, filed on Feb. 7, 2001.

(51) Int. Cl. H01S 3/20; H01S 3/091; H01S 3/094

(52) U.S. Cl. 372/53; 372/75

(57) ABSTRACT

The present invention provides for the generation of a controllable source of single photons generated one at a time using optical pumping of a single molecule at room temperature. A single fluorescent molecule is pumped by a light source so that the molecule is placed in its electronic excited state with high probability. The molecule then de-excites via the emission of a single photon, which can be collected by a means for collecting. The room temperature source of single photons is far more convenient and therefore more widely applicable. A high probability of single-photon emission for each incident pump pulse is provided, a property which is useful for transmission of sensitive data bits by the methods of quantum cryptography.

### CROSS-REFERENCE TO RELATED APPLICATIONS

This application is cross-referenced to and claims priority from U.S Provisional Application 60/266,955 filed Feb. 7, 2001, which is hereby incorporated by reference.

### STATEMENT REGARDING FEDERALLY SPONSORED RESEARCH OR DEVELOPMENT

This invention was supported in part by grant number MCB98 16947 from the National Science Foundation (NSF). The U.S. Government has certain rights in the invention.

### FIELD OF THE INVENTION

The present invention relates generally to optical quantum cryptography and information systems. More particularly, the present invention relates to a room temperature source of single photons based on a single molecule.

### BACKGROUND

The generation of non-classical states of light is of fundamental scientific and technological interest. For example, “squeezed states” enable measurements to be performed at lower noise levels than possible using classical light. Deterministic (or triggered) single-photon sources exhibit non-classical behavior in that they emit, with a high degree of certainty, just one photon at a user-specified time. In contrast, a classical source such as an attenuated pulsed laser emits photons according to Poisson statistics. A deterministic source of single photons could find applications in quantum information processing, quantum cryptography and certain quantum computation problems. The importance and utility of quantum information has been discussed in several review articles, see for example the special issue of Special Issue on quantum information, Phys. World 11(3) 1998 and Bennett C. H. et al. (1992) in a paper entitled Quantum Cryptography and published in Sci. Am. 267(4):50-57. A key attack, known as the beamsplitter attack, has also been described by Buttler, W. T. et al. (1998) in a paper entitled “Practical Free-Space Quantum key Distribution over 1 km”, and published in Phys. Rev. Lett. 81:3283-3286. Importantly, this attack can be avoided by using a single photon per pulse to transmit the cryptographic information.

Various schemes have been proposed to create a single-photon source, for example, involving single atoms in cavities (See e.g. Parkins A. S. et al. (1995) in a paper entitled Quantum-state mapping between multilevel atoms and cavity light fields and published in Phys. Rev. A 51:1578-1596; Cirac J. L. et al. (1997) in a paper entitled Quantum state transfer and entanglement distribution among distant nodes in a quantum network and published in Phys. Rev. Lett. 78:32210-3224; Kuhn A. et al. (1999) in a paper entitled Controlled generation of single photons from a strongly coupled atom-cavity system and published in Appl. Phys. B 69:373-377), or highly nonlinear cavities (See e.g. Imamoglu A. et al. (1997) in a paper entitled Strongly interacting photons on a nonlinear cavity and published in Phys Rev. Lett. 79:1467-1470). Such single-photon sources have, for example, only been demonstrated in some experiments at cryogenic temperatures. One method involves using a “turnstile” effect based on a Coulomb blockade for electrons and holes in a mesoscopic double barrier p-n junction (See e.g. Kim J et al. (1999) in a paper entitled A single-photon turnstile device and published in Nature 397: 500-503). A dilution refrigerator operating at 50 mK was crucial for minimizing the thermal energy background. Due to the sample geometry, the detection efficiency was limited to about 10⁻⁴, which made it difficult to measure the second-order intensity correlation of the emitted photons, an important diagnostic of the non-classical nature of the light. Another cryogenic method involves controlled excitation of a single molecule in a solid, in which a rapid adiabatic passage method is used to prepare the molecule in its fluorescent state (See e.g. Brunel, C. et al. (1999) in a paper entitled Triggered source of single photons based on controlled single molecule fluorescence and published in Phys. Rev. Lett. 83:2722-2725). Very narrow optical absorption lines are needed for this method, which require liquid helium temperatures (2K). The detection efficiency was limited to about 3×10⁻³. Yet another method involves a quantum dot single photon turnstile device that generates a train of single-photon pulses (See Michler P. et al. (2000) in a paper entitled A quantum dot single-photon turnstile device and published in Science 290:2282-2285). Controlled release of single-photons from their quantum dot device also requires cryogenic conditions (4K). Cryogenic temperatures are often difficult to produce, requiring a cryostat, a cryogen or refrigerator, and the associated equipment to monitor and control the sample temperature. These additional items add expense to the overall system. Accordingly, there is a need to develop new approaches to create single-photon sources.

Reports of photon antibunching for single molecules under continuous-wave excitation have appeared in the literature (See e.g. Fleury, L. et al. (2000) in a paper entitled Nonclassical photon statistics in single-molecule fluorescence at room temperature and published in Phys. Rev. Lett. 84:1148-1151). While the emitted photons cannot be emitted two at a time, the overall emission time of photons under continuous-wave excitation is random and is not useful for transmission of bits by quantum cryptography techniques. The observation of photon antibunching is a necessary but not sufficient condition for a controllable source of single photons. Accordingly, there is also a need for controlled emission of single photons.

### SUMMARY OF THE INVENTION

The present invention provides for the generation of a controllable source of single photons generated one at a time using optical pumping of a single molecule in a host at room temperature. A single fluorescent molecule is pumped by a light source (e.g. a pulsed pumping laser) so that the molecule is placed in its electronic excited state with high probability. The molecule then de-excites via the emission of a single photon, which can be collected by a means for collecting. In view of that which is stated above, it is the objective of the present invention to provide operation of the single-photon source at room temperature. It is still another objective of the present invention to generate single photons on demand. It is still another objective of the present invention to provide high probability of emission of a single photon for each pump pulse in order to maximize the amount of information that can be transmitted in a given time. It is still another objective of the present invention to provide a method for optically pumping a single molecule in order to maximize the probability of emission of a single photon. It is yet another objective of the present invention to provide a means for collecting the emitted photons with a high efficiency. The advantage of the present invention is that it enables one to generate single photons, one at a time, at room temperature based on the light emitted from a single molecule. Another advantage of the present invention is that the source probability of generation and collection efficiency of a single photon per pulse is large. Furthermore, a room temperature source of single photons is far more convenient and therefore more widely applicable. The present invention shows high probability of single-photon emission for each incident pump pulse, a property which is useful for transmission of sensitive data bits by the methods of quantum cryptography.

### BRIEF DESCRIPTION OF THE FIGURES

The objectives and advantages of the present invention will be understood by reading the following detailed description in conjunction with the drawings, in which:

FIGS. 1A-C show exemplary embodiments according to the present invention;

FIG. 2 shows a pumping scheme of a single molecule to the fluorescent state according to the present invention;

FIG. 3 shows examples of chemical structures according to the present invention;

FIG. 4 shows an example of a confocal fluorescence image according to the present invention; and

FIG. 5 shows an exemplary representation of a scanning microscope setup according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The present invention provides an optical device and method that provides a high performance, room temperature source of single-photons upon demand that would be a key component in an optical quantum cryptography and information/communication system. The present invention uses single photons, one at a time, to encode information in entangled polarization states to achieve the highest level of reliability. Triggered single photons are produced at a high rate, whereas the probability of simultaneous emission of two photons is nearly zero. This is a very useful property for secure quantum cryptography. The present invention is characterized by a room-temperature operation and improved performance compared to other triggered sources of single photons.

The present invention realizes a controllable source of single photons using optical pumping of a single molecule in a host. The present invention provides a device and method wherein a single molecule embedded in a host at ambient temperatures is pumped by a light pulse (e.g. a short laser pulse of sufficient energy) to place the single molecule in the excited emitting state with high probability. The single molecule then emits one and only one fluorescent photon for each pump pulse. A pumping pulse that also would place the molecule in the excited state with high probability would be a pulse of pulse area equal to π. Maximizing the probability of emission of a single photon is done by utilizing a pumped laser whose pulse width is much less than the excited state lifetime of a single molecule and by pumping into the vibronic sideband of the optical absorption. For sufficient pump pulse energy, the molecule can be placed into the highly emissive excited state with high probability. This approach is easier to implement than other pumping schemes such as adiabatic passage or the use of an inverting resonant laser pulse.

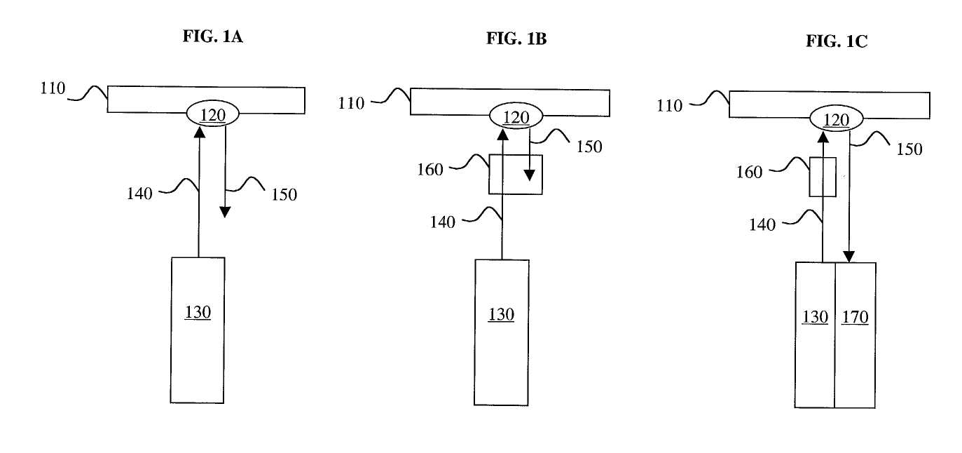

In general, the present invention is described in FIG. 1A as a host 110 that hosts a single molecule 120 and a light source 130 to supply a pump light pulse 140 to host 110 to excite single molecule 120 to an excited state after which single molecule 120 emits a single photon 150. Depending on the type of light source 130, the present invention also includes a means for directing 160 to direct the pump light pulse 140 to single molecule 120 as shown in FIG. 1B. In an exemplary embodiment shown in FIG. 1, a mode-locked laser could be used as light source 130 and a microscope is used as means for directing 160 to direct the pumping light to the single molecule as well as a means for collecting to collect the emitted photons for detection. However, the present invention is not limited to a particular type of laser to deliver the light pulse or mechanism to direct the pumped light pulse. The present invention is also not limited to having the means for directing 160 and the means for collecting 170 as separate devices as shown in FIG. 1C. Examples of means for collecting 170 are, for instance, but not limited to, a microscope, an optical fiber or an optical cavity such as a dielectric sphere, disk, or other optical resonator. For example, one could couple the emitted photon to an optical cavity where only one cavity mode couples to the photon. This optical cavity mode then efficiently collects the fluorescence.

Examples of a single molecule are, for example, but not limited to, a terrylene molecule, a dibenzoanthanthrene molecule, a pentacene molecule, a perylene molecule or derivatives of these molecules. In general, a single molecule is a planar aromatic molecule. The single molecule is also a planar aromatic hydrocarbon with an electric dipole allowed lowest electronic excited state. Furthermore, a single molecule is a laser dye, such as, but not limited to, rhodamine or the like. The solid host is, for example, but not limited to, a p-terphenyl or a molecular crystal, such as naphthalene, durene, or similar molecule. Furthermore, the solid host is also, for example, an amorphous organic solid. Examples of a single molecule embedded in a solid host are molecules and hosts which provide a high stability at room temperature, providing 10⁸ photons or more. Examples of this high stability include the molecule terrylene doped into a transparent p-terphenyl crystal, or dibenzoanthanthrene in a similar molecular crystal host.

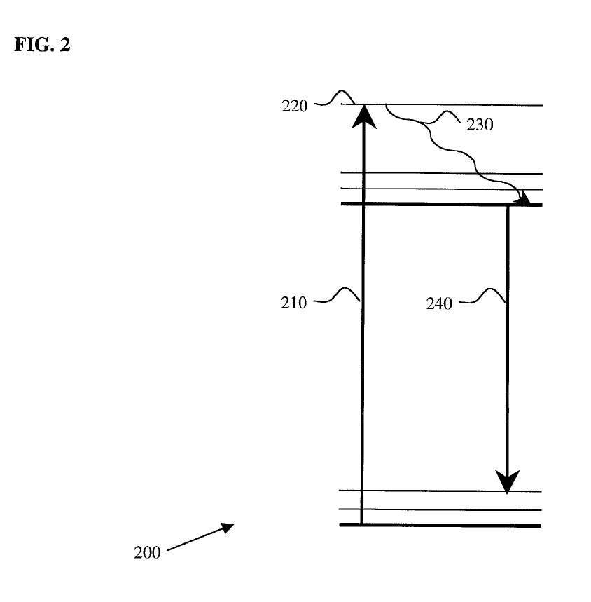

FIG. 2 shows a pumping scheme 200 of a single molecule to the fluorescent state. The pump photons 210 excite the single molecule high into the vibrational manifold of the first electronic excited state 220. With a sufficiently short pump pulse with high energy, the single molecule can be placed in the vibronic level with very high probability. The single molecule then de-excites 230 via the usual process of vibrational relaxation on the time scale of picoseconds. The single molecule is chosen to have a very high quantum yield for fluorescence, and then an emitted photon 240 is produced during the fluorescence lifetime of a few ns. The emission of a single photon 240, can be collected by a means for collecting.

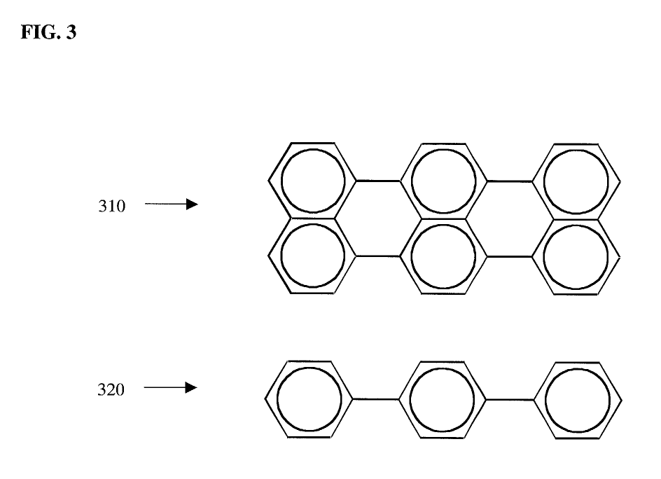

As an exemplary embodiment, FIG. 3 shows the chemical structures of terrylene 310 and pterphenyl 320 as they have been used to provide the required single molecule in host respectively. The sample is a sublimed crystal flake (few μm thickness) of p-terphenyl doped with terrylene at low concentration of about 10⁻¹¹ moles/mole. Terrylene 310 fluoresces around 579 nm in the p-terphenyl crystal, and has a fluorescence quantum yield of unity.

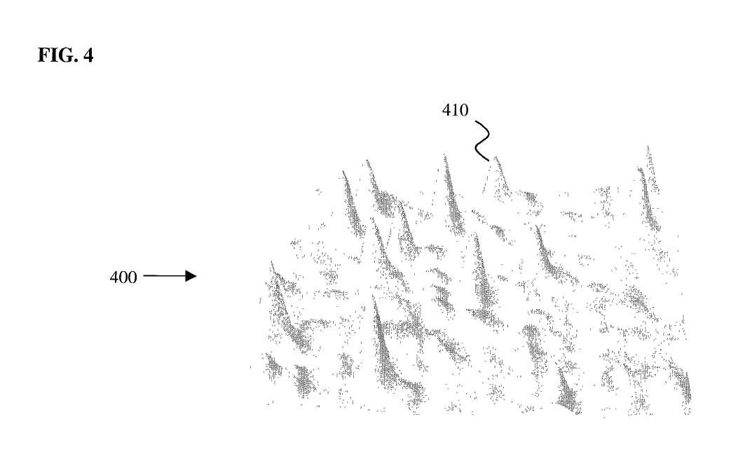

FIG. 4 shows a confocal fluorescence image 400 (10 μm ×10 μm) of single terrylene molecules embedded in crystalline p-terphenyl with continuous-wave (cw) excitation at 532 nm of about 1.5 μW, signal-to-background ratio >5. The individual isolated “mountains” 410 correspond to single terrylene molecules. For the generation of single photons on demand, the pump laser is switched to a pulsed source, and the focal spot is placed on top of one of the “mountains” 410, thus selecting one and only one molecule for excitation.

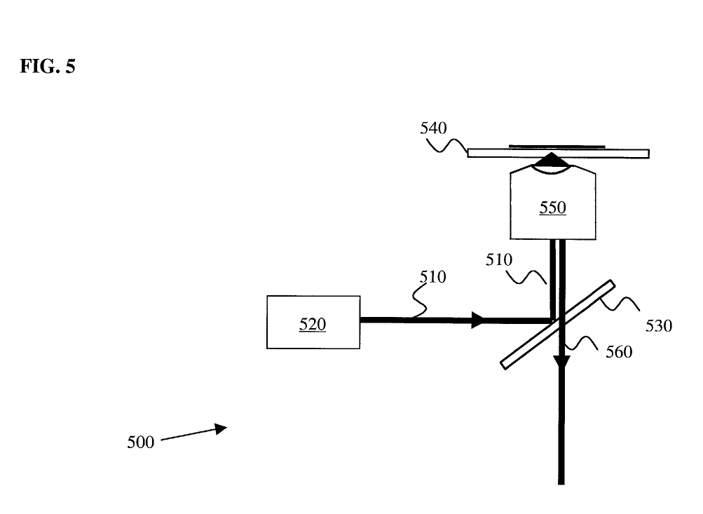

FIG. 5 shows a schematic and exemplary representation 500 of a scanning confocal microscope setup used to characterize the single-molecule emission. In this example, green laser excitation 510 was derived from light source 520 which was an actively mode-locked picosecond Nd-YAG laser from Lightwave Electronics (model 131, pulse width 35 ps, repetition rate 100 MHz, average 1.06 μm power 220 mW). The pulsed green light 510 at 532 nm was produced by single pass second-harmonic generation in a periodically poled lithium niobate crystal (a maximum average green power of 0.2 mW was obtained for an average near infrared power of 10 mW). The excitation beam 510 was directed first to a dichroic mirror 530 and then focused on the sample plane 540 by a 1.4 numerical aperture (NA) oil-immersion objective 550 of an inverted microscope. The fluorescence photons were collected by this objective, and filtered from the residual excitation light by a holographic notch filter and long pass glass filter. The emitted fluorescence 560 consists of a single photon for each pump pulse.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For instance, a possible variation and modification is the use of quantum dots or atomic ions in a solid as the emitting entities. Another variation and modification is a modified collection geometry to improve the efficiency of the collection and thus the single-photon character in the detected signal, such as 4π collection optics or attachment of the sample to the end of an optical fiber. Yet another variation and modification is the use of two or more molecules within the same focal volume to emit two or more entangled photons at a time. All such variations are considered to be within the scope and spirit of the present invention as defined by the following claims and their legal equivalents.

What is claimed is:

1. A device for generating single photons one at a time at room temperature, comprising:
(a) a single molecule; and
(b) a light source for delivering a light pulse to said single molecule to excite said single molecule to an excited state after which said single molecule emits said single photon.

2. The device as set forth in claim 1, further comprises a means for directing said light pulse to said single molecule.

3. The device as set forth in claim 1, wherein said excited state comprises a vibrational manifold.

4. The device as set forth in claim 1, further comprises a means for collecting said single photon.

5. The device as set forth in claim 1, wherein said single molecule has a high quantum yield for photon emission.

6. The device as set forth in claim 1, wherein said single molecule has a fluorescence lifetime on the order of ns.

7. The device as set forth in claim 1, wherein said single molecule is a terrylene molecule, a derivative of said terrylene molecule, a dibenzoanthanthrene molecule, a derivative of said dibenzoanthanthrene molecule, a pentacene molecule, a derivative of said pentacene molecule, a perylene molecule or a derivative of said pentacene molecule.

8. The device as set forth in claim 1, wherein said single molecule is a planar aromatic hydrocarbon with an electric dipole allowed lowest electronic excited state.

9. The device as set forth in claim 1, wherein said single molecule is a planar aromatic molecule.

10. The device as set forth in claim 1, wherein said single molecule is a laser dye.

11. The device as set forth in claim 1, wherein said single molecule is in a solid host.

12. The device as set forth in claim 11, wherein said solid host is p-terphenyl.

13. The device as set forth in claim 11, wherein said solid host is a molecular crystal.

14. The device as set forth in claim 11, wherein said solid host is an amorphous organic solid.

15. The device as set forth in claim 1, wherein said light source is a pulsed pumping laser.

16. A method for generating single photons one at a time at room temperature, comprising the steps of:
a. providing a single molecule; and
b. delivering a light pulse with a light source to said single molecule to excite said single molecule to an excited state after which said single molecule emits said single photon.

17. The method as set forth in claim 16, further comprises the step of providing a means for directing said light pulse to said single molecule.

18. The method as set forth in claim 16, wherein said excited state comprises a vibrational manifold.

19. The method as set forth in claim 16, further comprises the step of providing a means for collecting said single photon.

20. The method as set forth in claim 16, wherein said single molecule has a high quantum yield for photon emission.

21. The method as set forth in claim 16, wherein said single molecule has a fluorescence lifetime on the order of ns.

22. The method as set forth in claim 16, wherein said single molecule is a terrylene molecule, a derivative of said terrylene molecule, a dibenzoanthanthrene molecule, a derivative of said dibenzoanthanthrene molecule, a pentacene molecule or a derivative of said pentacene molecule, a perylene molecule or a derivative of said perylene molecule.

23. The method as set forth in claim 16, wherein said single molecule is a planar aromatic hydrocarbon with an electric dipole allowed lowest electronic excited state.

24. The method as set forth in claim 16, wherein said single molecule is a planar aromatic molecule.

25. The method as set forth in claim 16, wherein said single molecule is a laser dye.

26. The method as set forth in claim 16, wherein said single molecule is provided in a solid host.

27. The method as set forth in claim 26, wherein said solid host is p-terphenyl.

28. The method as set forth in claim 26, wherein said solid host is a molecular crystal.

29. The method as set forth in claim 26, wherein said solid host is an amorphous organic solid.

30. The method as set forth in claim 16, wherein said light source is a pulsed pumping laser.

31. A controllable source of single photons generated one at a time using optical pumping of a single molecule in a solid at room temperature.

32. A single photon obtained by optical pumping of a single molecule in a solid at room temperature.

33. A source of single photons obtained one at a time at room temperature by pulsed optical excitation of a single highly fluorescent molecule.

34. A single photon obtained by a pulsed optical excitation of a single highly fluorescent molecule at room temperature.

35. A system for collecting single photons one at a time at room temperature, comprising:
a. a single molecule;
b. a light source for delivering a light pulse to said single molecule to excite said single molecule to an excited state after which said single molecule emits said single photon; and
c. a means for collecting said single photon.

36. The system as set forth in claim 35, further comprises a means for directing said light pulse to said single molecule.

37. The system as set forth in claim 35, wherein said excited state comprises a vibrational manifold.

38. The system as set forth in claim 35, wherein said single molecule has a high quantum yield for photon emission.

39. The system as set forth in claim 35, wherein said single molecule has a fluorescence lifetime on the order of ns.

40. The system as set forth in claim 35, wherein said single molecule is a terrylene molecule, a derivative of said terrylene molecule, a dibenzoanthanthrene molecule, a derivative of said dibenzoanthanthrene molecule, a pentacene molecule or a derivative of said pentacene molecule, a perylene molecule or a derivative of said perylene molecule.

41. The system as set forth in claim 35, wherein said single molecule is a planar aromatic hydrocarbon with an electric dipole allowed lowest electronic excited state.

42. The system as set forth in claim 35, wherein said single molecule is a planar aromatic molecule.

43. The system as set forth in claim 35, wherein said single molecule is a laser dye.

44. The system as set forth in claim 35, said single molecule is in a solid host.

45. The system as set forth in claim 45, wherein said solid host is p-terphenyl.

46. The device as set forth in claim 45, wherein said solid host is a molecular crystal.

47. The device as set forth in claim 45, wherein said solid host is an amorphous organic solid.

48. The system as set forth in claim 35, wherein said light source is a pulsed pumping laser.

49. The system as set forth in claim 35, wherein said means for collecting comprises an optical cavity resonator.

50. The system as set forth in claim 35, wherein said means for collecting comprises an optical fiber.
